(19) United States
(12) Patent Application Publication
(10) Pub. No.: US 2008/0180093 A1
(43) Pub. Date: Jul. 31, 2008

(54) MEASURING ELEMENT WITH A TRACK FOR DETERMINING A POSITION AND CORRESPONDING MEASURING METHOD

(75) Inventors: ROLAND FINKLER, Erlangen (DE); Hans-Georg Kopken, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/767,845

(22) Filed: Jun. 25, 2007

Related U.S. Application Data
(63) Continuation of application No. PCT/EP05/56866, filed on Dec. 16, 2005.

(30) Foreign Application Priority Data
Dec. 23, 2004 (DE) 10 2004 062 278.7

(51) Int. Cl. G01B 7/14

(52) U.S. Cl. 324/207.24

(57) ABSTRACT

A measuring element and a measuring method for determining a position are disclosed which use a track with a material measure that is scanned by at least two sensors. The material measure is embodied in such a way that the sensors generate a modulated sinusoidal trace signal as an output signal for determining the position. In this way, the invention provides a simple measuring element and a simple measuring method for determining a position, especially an absolute position.

### CROSS-REFERENCES TO RELATED APPLICATIONS

This application is a continuation of prior filed copending PCT International application no. PCT/EP2005/056866, filed Dec. 16, 2005, which designated the United States and has been published but not in English as International Publication No. WO 2006/069925 A1 and on which priority is claimed under 35 U.S.C. §120, and which claims the priority of German Patent Application, Serial No. 10 2004 062 278.7, filed Dec. 23, 2004, pursuant to 35 U.S.C. 119(a)-(d), the content(s) of which is/are incorporated herein by reference in its entirety as if fully set forth herein.

### FIELD OF THE INVENTION

The invention relates to a measuring element for measuring a position value with a track having a material measure. The invention further relates to a corresponding measuring method.

### BACKGROUND OF THE INVENTION

Transmitters are used to determine a position, in particular an absolute position of a machine axis of, for example, a machine tool, production machine and/or a robot. Commercially available transmitters for detecting the position have a measuring element in form of a linear element or a rotary element, the measuring element having one or more tracks with a respective material measure, for example, in form of increments that are scanned by sensors to determine the position.

European patent 0 116 636 B1 discloses a transmitter where an absolute position is determined via a so-called PRBS track that has increments in the form of “zeros” and “ones”. An additional fine resolution of the absolute position is performed by detecting the position of transitions between the increments. Disadvantageously, on the one hand, an additional sensor system is required for detecting the transitions and, on the other hand, eight or more sensors are usually required for determining the position.

European patent EP 0 503 716 B1 discloses a transmitter for determining an absolute position, a commercially available absolute track and an incremental track being combined to form a single combined track, the material measure having pseudo-randomly distributed individual increments. Disadvantageously, however, eight or more sensors are usually required for determining the position.

A length measuring system from the company RSF-Elektronik from the year 1992 using both an incremental track and an absolute track for determining a position is known from the publication “Das Transformationsmessverfahren—Ein Beitrag zur Gestaltung von Absolutmesssystemen” [“The transformation measuring method—a contribution to the fashioning of absolute measuring systems”], Uwe Kippung, T U Chemnitz, 1997, dissertation, page 11.

The principle of a sin/cos transmitter is disclosed in German Offenlegungsschrift DE 27 29 697 A1.

A rotary sensor for a combination drive is known from publication “Drehsensor für einen Kombinationsantrieb” [“Rotary sensor for a combination drive”], www.ip.com, IPCOM000028605D, Christof Nolting, Hans-Georg Köpken, Günter Schwesig, Rainer Siess.

However, there is still a need for a simple measuring element and a simple measuring method for determining a position, in particular an absolute position.

### SUMMARY OF THE INVENTION

According to one aspect of the invention, a measuring element includes a track having a material measure, and at least two sensors scanning the material measure for determining a position value and generating as an output signal a frequency-modulated sinusoidal track signal, wherein the frequency of the track signal increases monotonically or decreases monotonically when the position value increases.

According to another aspect of the invention, a measuring element includes a track having a material measure, and at least two sensors scanning the material measure for determining a position value and generating as an output signal an amplitude-modulated sinusoidal track signal, wherein the amplitude-modulated sinusoidal track signal has a single frequency.

According to yet another aspect of the invention, a measuring method for determining a position value with a track having a material measure includes the steps of scanning the material measure with at least two sensors, and generating a sensor output signal in form of a frequency-modulated sinusoidal track signal to determine the position value, wherein the frequency of the frequency-modulated track signal increases monotonically or decreases monotonically with increasing position value.

According to yet another aspect of the invention, a measuring method for determining a position value with a track having a material measure includes the steps of scanning the material measure with at least two sensors, and generating a sensor output signal in form of an amplitude-modulated sinusoidal track signal having a single frequency to determine the position value.

The inventive measuring element and the inventive measuring method have the advantage that substantially fewer sensors are required for determining the absolute position in comparison to the prior art. Furthermore, only a single track is required for determining the absolute position, and there is also no need for a sensor system for detecting transitions of the increments in the case of the inventive measuring element and of the inventive measuring method.

Advantageously, the material measure may be scanned by at least three sensors for determining a position, since the position can then always be determined uniquely.

Advantageously, the measuring element may be configured in the shape of a rotationally symmetrical element whose outer contour has a frequency modulated sinusoidal shape. When it is necessary during measurement for reasons of mechanical design to rotate the scanning head and/or the measuring element in rotary fashion about the axis of rotation of the measuring element, this has no influence on the measurement or, consequently, on the determination of the position, owing to the specific design of the measuring element.

Advantageously, a transmitter can be equipped with the inventive measuring element since, inter alia, the transmitter can be of very compact design owing to the fact that the invention requires only a single track for acquiring the position.

Transmitters having the inventive measuring element may be useful, in particular, in the technical field of machine tools, production machines and/or robots.

Moreover, the position can advantageously be determined by determining in a first step from the track signals of the sensors a coarse position, and determining in a second step the position through interpolation from the coarse position. As a result, the position can be determined in a particularly simple way.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a measuring element according to the invention,

FIG. 2 shows a track signal according to the invention,

FIG. 3 shows another frequency modulated track signal according to the invention,

FIG. 4 shows another frequency modulated track signal according to the invention,

FIG. 5 shows a plot of the positions in a Cartesian coordinate system,

FIG. 6 shows two additional frequency modulated track signals from two sensors according to the invention,

FIG. 7 shows an amplitude-modulated track signal, and

FIG. 8 shows another measuring element with scanning head according to the invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

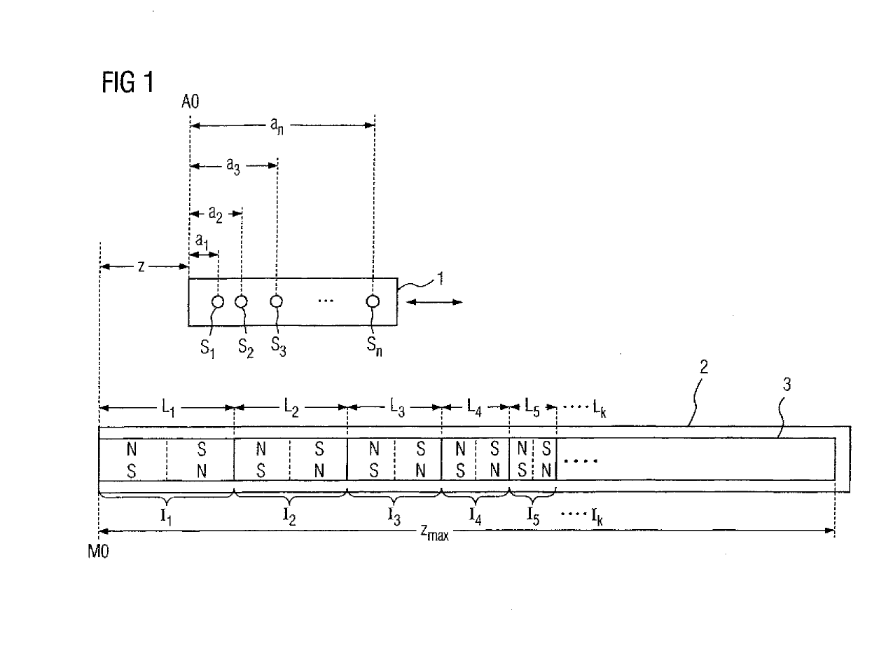

Turning now to the drawing, and in particular to FIG. 1, there is shown a schematic diagram of a measuring element 2 according to the invention. The measuring element 2 has a track 3 with a material measure. The material measure in the exemplary embodiment consists of increments I₁ to Iₖ that are scanned by sensors S₁ to Sₙ for determining a position z. Each increment I₁ to Iₖ has in this case two oppositely magnetized areas (the separation of the individual areas being illustrated in FIG. 1 by a dashed line). The sensors S₁ to Sₙ are arranged on a scanning head 1 and exhibit the spacings a₁ to aₙ from a zero point A0 of the scanning head. The position z specifies the distance from the zero point MO of the measuring element 2 to the zero point A0 of the scanning head. The measuring element 2 illustrated in FIG. 1 is a so-called linear measuring element, that is to say the position of a linear movement is measured. The scanning head 1 moves in this case along the measuring element 2 in the direction of the double arrow at a uniform spacing, and the position z is measured by using at least two sensors (for example the sensors S1 and S2), which are designed as magnetic sensors in the exemplary embodiment, to scan the magnetic field generated by the increments I₁ to Iₖ. By contrast with a commercially available material measure in the case of which all increments generally exhibit a constant period length L₁ to Lₖ, the material measure of the inventive measuring element in accordance with the exemplary embodiment exhibits increments whose period lengths L₁ to Lₖ decrease with increasing position z (it being possible, as an alternative, also to design the material measure such that the material measure exhibits increments whose period lengths L₁ to Lₖ increase with increasing position z, or whose period lengths L₁ to Lₖ simply assume different values). If, now, the scanning head 1, and thus, for example, the sensor S1, is moved from left to right along the measuring element 2, a frequency modulated sinusoidal so-called track signal with decreasing period length, that is to say increasing frequency is output as output signal of the sensor, the lengths L₁ to Lₖ being yielded as period lengths.

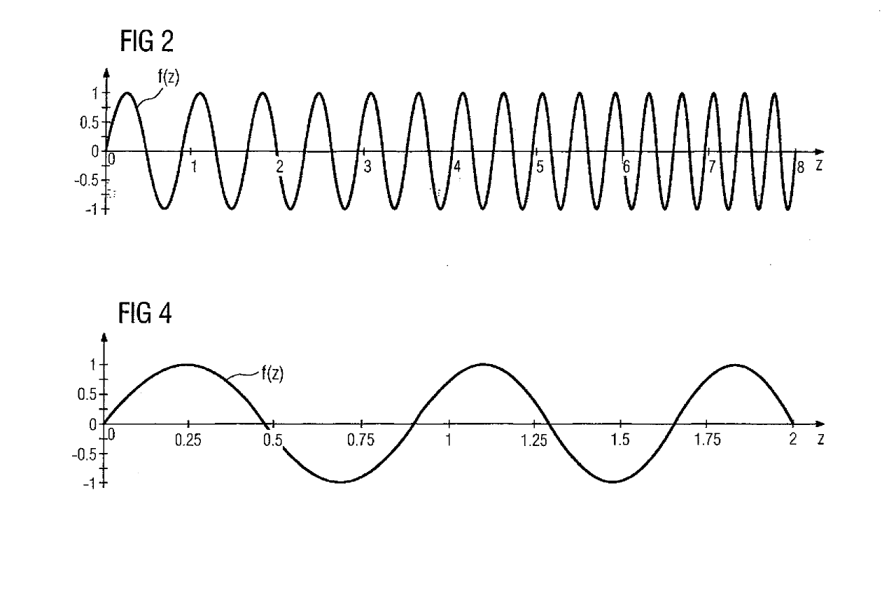

Such a track signal f(z) generated by the sensor S₁ as output signal is illustrated in FIG. 2.

As a consequence of the scanning of the material measure, each of the sensors S₁ to Sₙ outputs as output signal a respective modulated sinusoidal track signal f(z) that is described mathematically by the track function f(z), the nth sensor supplying the signal

f(z+aᵢ) (30010).

The track signal f(z) is frequency modulated in the exemplary embodiment. An example of the inventive track signal f(z) is illustrated in FIG. 2.

A first approximate value in the form of a coarse position for the position z to be determined is determined in the following exemplary embodiments through a coarse evaluation from the sensor signals, initially by means of determining one or more auxiliary variables. The position z is then determined exactly through a subsequent fine evaluation by means of interpolation.

A first exemplary embodiment of an evaluation of the track signal for determining the position z is explained below.

In this exemplary embodiment, the track signal, that is to say the track function, is given by

$$\begin{matrix}f ( z ) = cos ( 2 π {\int }_{0}^{z} d {z}^{‵} / L ( {z}^{‵} ) ) \\ = cos ( 2 π ( z - {\sum }_{κ = 1}^{k - 1} {L}_{κ} ) / L ( z ) ) \\ = cos ( 2 π ( z - {\sum }_{κ = 1}^{k - 1} {L}_{κ} ) / {L}_{k} )\end{matrix} \\ for {\sum }_{κ = 1}^{k - 1} {L}_{κ} \leq z < {\sum }_{κ = 1}^{k} {L}_{κ} , \qquad ( 51010 a )$$

with a stepwise running function of the profile of the period lengths Lₖ of the increments of the form

$$L ( z ) := {L}_{k} for {\sum }_{κ = 1}^{k - 1} {L}_{κ} \leq z < {\sum }_{κ = 1}^{k} {L}_{κ} \qquad ( 51010 b )$$

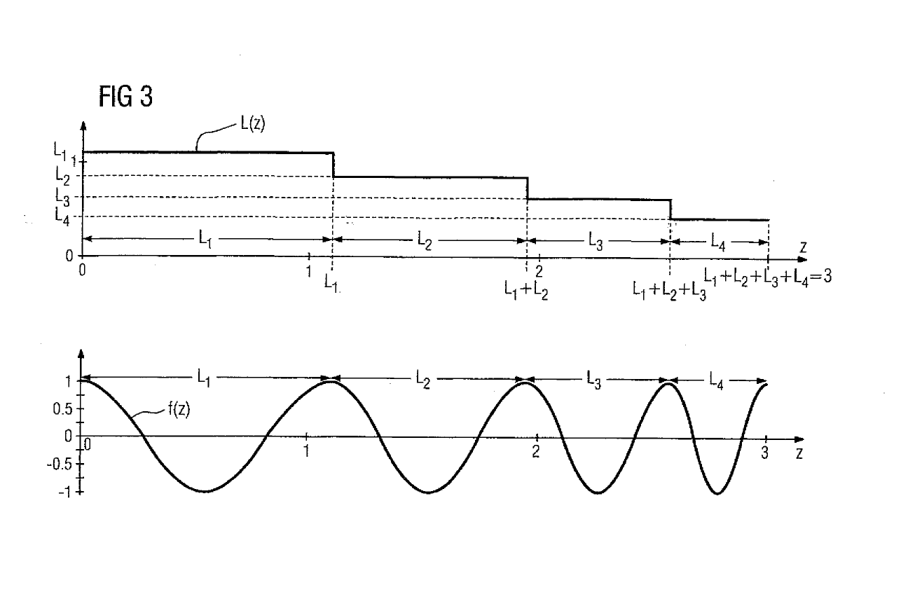

with positive, pair-wise differing period lengths L₁, L₂, . . . , Lₖ (see FIG. 3).

The scanning head 1 in accordance with FIG. 1 in this case has at least two sensors whose spacing a₂−a₁ is to be very small by comparison with the period lengths occurring, that is to say

a₂−a₁<<Lₖ, k=1, 2, . . . K (51040).

In order to determine the position z being sought, the track signal of the first sensor and the difference between the two track signals of the first sensor and of the second, neighboring sensor are evaluated, that is to say the variables

x:=f(z+a₁), y:=f(z+a₂)−f(z+a₁) (51050a, b)

are considered. Owing to equation (51010a), it follows to a good approximation that

x=cos(α), y=−[2π(a₂−a₁)/Lₖ] sin(α) (51060a, b)

where

$$α := 2 π {\int }_{0}^{z + {a}_{1}} d {z}^{‵} / L ( {z}^{‵} ) = 2 π ( z + {a}_{1} - {\sum }_{κ = 1}^{k - 1} {L}_{κ} ) / {L}_{k} ) \\ for {\sum }_{κ = 1}^{k - 1} {L}_{κ} \leq z + {a}_{1} < {\sum }_{κ = 1}^{k} {L}_{κ} , \qquad ( 51060 c ) ,$$

equation (51060a) holding exactly for x. Using the trigonometric identity (sin(φ))²+(cos(φ))²=1, it follows from this, firstly, that
x²+{Lₖ/[2π(a₂−a₁)]}²y²=1, and therefore, furthermore, that

Lₖ=2π(a₂−a₁)(1−x²)^{1/2}/|y|. (51070)

(The case y=0 will be examined further below.) By comparing the right-hand side of this equation with the values Lₖ, it is already possible therefrom to infer the interval in which the position sought, that is to say the position z, is located, that is to say it is possible to determine that k for which

$${\sum }_{κ = 1}^{k - 1} {L}_{κ} \leq z + {a}_{1} < {\sum }_{κ = 1}^{k} {L}_{κ}$$

holds (determination of the coarse position; coarse evaluation).

The exact position is obtained, finally, as:

$$z = - a 1 + {\sum }_{κ = 1}^{k - 1} {L}_{κ} + {L}_{k} atan 2 ( - y {L}_{k} / ( 2 π ( {a}_{2} - {a}_{1} ) ) , x ) / ( 2 π ) if atan 2 ( - y {L}_{K} / ( 2 π ( {a}_{2} - {a}_{1} ) ) , x ) \geq 0 = - a 1 + {\sum }_{k = 1}^{k - 1} {L}_{K} + {L}_{k} [ 1 + atan 2 ( - y {L}_{k} / ( 2 π ( {a}_{2} - {a}_{1} ) ) , x ) / ( 2 π ) ] \qquad ( 51080 )$$

otherwise (fine evaluation by means of interpolation), a tan 2(Y, X) denoting for real X, Y the argument of the complex number X+jY (j²=−1) (−π≦a tan 2(Y, X)≦π).

For y=0, |x|=1, and a division 0 by 0 results on the right-hand side of equation (51070). In this case, the equation cannot be solved for z. Two possible solutions are on offer for this problem:

Possible solution 1: acceptance is given to the existence of such singular points and/or intervals for which the position z cannot be uniquely determined. In practice, this can suffice, for example, in applications where the scanning head 1 is normally in continuous movement, and the position z is interrogated at equidistant scanning instants in a fixed time frame in order to control this movement. If then no unique position z can be determined at a specific scanning instant, it can suffice for the position z only to be available again in the next, or one of the next scanning instants. If appropriate, it is also acceptable to move the scanning head 1 a little in a targeted fashion in order to enter a range in which z can again be determined uniquely.

Possible solution 2: at least two further sensors are provided in the scanning head 1, the spacing a₄−a₃ of which likewise being very small in comparison to the period lengths occurring, and the variables

x₃₄:=f(z+a₃), y₃₄:=f(z+a₄)−f(z+a₃) (51090a,b)

are evaluated in accordance with the first two sensors, which leads to the second conditional equation

L(z+a₃)=2π(a₄−a₃)(1−x₃₄²)^{1/2}/|y₃₄| (51100).

It is always possible in this case, by selecting a₃ in a suitable way, to achieve that whenever the equation (51070) cannot be solved for z because y=0, it is possible to solve (51100) for z.

A further exemplary embodiment for evaluating the track signal for determining the position z is explained below. The scanning head 1 in accordance with FIG. 1 has in this case at least two sensors whose spacing a₂−a₁ is not very small in comparison to the period lengths occurring.

The track signal is given in this case by

f(z)=sin((1+b(z))2πz/L), 0≦z≦zₘₐₓ (52010)

zₘₐₓ: length of the track
with a suitable function b(z),
in which case, for example, it holds that

b(z)=z/c (52015).

Such a track signal f(z) according to equation (52010) with b(z) according to equation (52015) with L=1 and c=8 is illustrated in FIG. 4.

The scanning head 1 has at least two sensors (n≧2) with a₂−a₁=L/4. For the sake of simplicity, it is assumed for what follows that

a₁=0 and a₂=L/4. (52020a, b)

In accordance with what has been said above, the first sensor supplies the track signal x, and the second sensor the track signal y, where

x:=f(z), y:=f(z+L/4) (52030a, b)

It is therefore possible to write

x=sin(α), y=cos(α+δ) (52040a, b)

with

α:=(1+b(z))2πz/L,

δ:=(b(z+L/4)−b(z))2πz/L+b(z+L/4)π/2. (52050a, b).

It may now be assumed from what follows that equation (52015) holds for b(z). This simplifies the last two equations to

α:=(1+z/c)2πz/L, δ:=[(2z+L/4)/c]π/2. (52055a, b)

As an aid to comprehension: for the limit case b(z)=0 (and c→∞) it follows that:

f(z)=sin(2πz/L), α=2πz/L, δ=0, x=sin(α), y=cos(α), (52060)

and this corresponds to the commercially available so-called sin/cos transmitter according to the prior art. In this case, the angle α can be determined from the measured values x, y up to multiples of 2π, and therefore z can be determined up to multiples of L, that is to say although the position can be determined within a period L, the period itself cannot be determined. However, if 0≦c≦∞ is selected it is then also possible to determine the period, as shown below.

The idea here is that the variable δ in equation (52040a, b) vanishes in the case of an ideal sin/cos transmitter according to the prior art, and corresponds to the so-called phase error δ of the transmitter in the case of a real sin/cos transmitter. The inventive solution is based on the fact that, on the one hand, in accordance with equation (52055b) this phase error δ is uniquely related to the position z being sought and, on the other hand, can be determined directly from the measured values x, y. Altogether therefore, z can be determined from x,y. The first step in deriving the required formulas is to transform y=cos(α+δ) (52040b) with the aid of the trigonometric identity

cos(φ+ψ)=cos(φ)cos(ψ)−sin(φ)sin(ψ)

into the equation

y=cos(α)cos(δ)−sin(α)sin(δ). (52070).

The following is obtained after rearranging and subsequently squaring:

[y+sin(α)sin(δ)]²=[cos(α)]²[cos(δ)]² (52080)

from which it follows further with the trigonometric identity (sin(φ))²+(cos(φ))²=1 and
x=sin(α) (52404a) that

[y+x sin(δ)]²=(1−x²)(1−(sin(δ))²) (52090).

Using the abbreviation

r:=sin(δ) (52100),

the quadratic equation

r²+2xyr+(x²+y²−1)=0 (52110)

is yielded by multiplying and rearranging, the solutions being

r=−xy±(x²y²−x²−y²+1)^{1/2} (52120).

It thus follows that r can firstly be determined from the measured values x, y. If, furthermore, equation (52100) is solved for δ, that is to say

δ=2qπ+arc sin(r) or δ=(2q+1)π−arc sin(r) (q=0, ±1, ±2 . . . ), (52130)

it is then possible to determine δ further. If, furthermore, equation (52055b) is solved for z, that is to say

z=cδ/π−L/8, (52180)

the position z being sought is finally obtained. Owing to the ambiguities in the two equations (52120) and (52130), a number of solutions for z would initially be obtained using the procedure previously described.

However, it is finally possible to obtain a unique solution at the end by inserting the various solutions in equation (52030a, b) and comparing the values yielded therefrom for x, y to the actual measured values x, y. The following computational scheme for z is thereby arrived at overall:

Determination of the coarse position in a first step

1) determine

r₁:=−xy−(x²y²−x²−y²+1)^{1/2},

r₂:=−xy+(x²y²−x²−y²+1)^{1/2} (52200a,b)

2) determine thereby

δ_{k,m}:=kπ+(−1)^{k}arc sin(rₘ) for k=0, 1, . . . ceil ((zₘₐₓ+L/8)/c+½), m=1.2 (52220)

ceil(χ) denoting the smallest whole number ≧χ.
3) Determine thereby

z_{k,m}:=cδ_{k,m}/π−L/8

for k=0, 1, . . . , ceil((zₘₐₓ+L/8)/c+½), m=1.2 (52230).

In order to find what is relevant from these numerous solutions, the latter are substituted in equation (52030a, b), thus determining the values

X_{k,m}:=f(z_{k,m}) and/or y_{k,m}=f(z_{k,m}+L/4), (52240a, b)

which correspond to these solutions. The solution being sought is now precisely that for which these valves are identical to the actual measured values x, y.

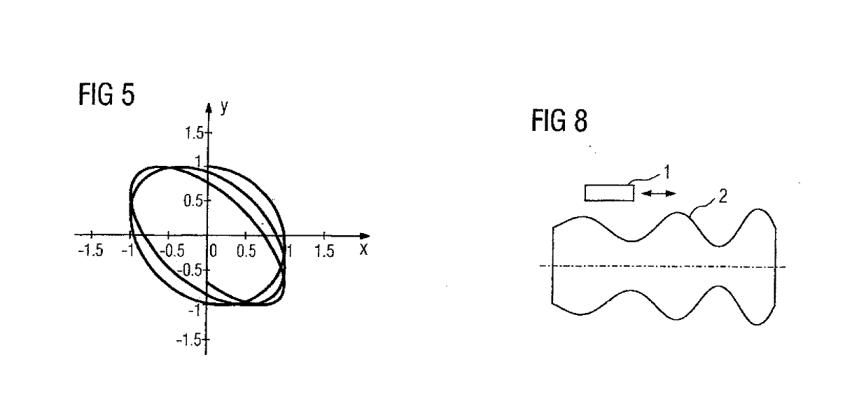

Nevertheless, a number of possible solutions are still obtained for this at some singular points, as may be illustrated with the aid of the locus curve, illustrated in FIG. 5, of the measured values x(z), y(z) in the xy plane for f(z) according to equation (52010) with b(z) according to equation (52015) and L=1, c=8.

The locus curve of the points (x, y) is drawn for all positions from the value range in FIG. 5. Since the values x and y in this case repeatedly traverse the value range from −1 to 1, this curve also repeatedly touches the lines x=−1, x=+1, y=−1, y=+1, and therefore repeatedly intersects itself. In the points of intersection thereby produced, there is then a corresponding number of values for the position z that lead in each case to the same measured values x, y. Since, in practice, the measured values x, y can be determined only with a limited accuracy, and, moreover, the computational accuracy is also only limited, there are in practice not only singular points, but finite intervals for the position z in which the latter cannot be uniquely determined with the general knowledge of x, y. Two possible solutions are on offer for this problem:

Possible solution 1: in accordance with the preceding exemplary embodiment.

Possible solution 2: there is provided in the scanning head at least one third sensor that, in accordance with equation (30010), outputs as output signal the track signal

y₃:=f(z+a₃) (52250).

By way of example, at the location of a singular point f(z_{k,m}+a₃) is, furthermore, determined for the solutions z_{k,m} under consideration, and is compared with the measured value y₃. The correct solution is then precisely that z_{k,m}, for y₃=f(z_{k,m}+a₃) which is valid.

The solution thus found agrees with the actual position generally only approximately, because of measuring errors and limited computational accuracy. To this extent, what has been said above constitutes only a coarse evaluation for the purpose of determining a coarse position.

There are various possibilities for the subsequent fine evaluation with which the position z being sought can be determined numerically with yet more accuracy by means of interpolation. Two of these are described below.

The basic idea in the case of the first method is to interpret δ as phase errors and x, y as track signals of an otherwise ideal sin/cos transmitter, to correct the track signals in accordance therewith and, finally, to calculate the actual position from the corrected track signals. It is supposed for this method that the parameter c in equation (52015) is positive and, furthermore, that the variable δ in accordance with equation (52055b) is smaller than π/2 for all zs occurring, typically smaller than π/3.

By correspondingly interpreting δ as phase error, the corrected track signals

x_{c}:=x, y_{c}:=(y+x sin(δ))/cos(δ), (52260a, b)

for which it holds that

x_{c}:=sin(α), y_{c}:=cos(α) (52265a, b)

are thereby obtained from x, y. The value of δ required for calculating y_{c} in accordance with equation (52260b) can, for example, be determined in accordance with equation (52055b) with the position z from the coarse evaluation. Alternatively, that δ_{k,m} according to equation (52220) which led to the correct value for z in the coarse evaluation can also be used for δ.

The following possible values for α are yielded therefrom, in turn:

α=αₖ=a tan 2(x_{c},y_{c})+k2π(k=0,1,2, . . . ) (52270).

On the other hand,

α=[1−L/(8c)+δ/π][δ/π−L/(8c)](c/L)2π; (52275)

is obtained by eliminating z from equation (52055a, b).

By contrast with equation (52270) this value is unique, but not so accurate numerically, because it originates from the coarse evaluation. Consequently, it is used here only for the purpose of determining the parameter k in equation (52270) such that a according to equation (52270) most closely approaches the α according to equation (52275), and determines with this k the exact value of α according to equation (52270).

After solving (52055a) for z and substituting these values, the following is finally obtained therefrom as possible values for the position z:

Z=(c/2){[1+(4L/c)α/(2π)]^{1/2}−1} (52280)

(the other solution of the quadratic equation is left out here since, owing to equation (52010), z is not negative.

The second method for fine evaluation is described below:

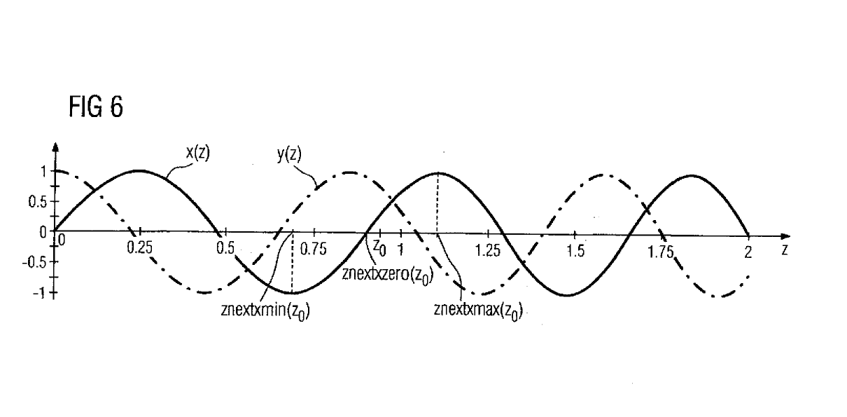

Let z₀ be the value, found by the coarse evaluation, for the position z being sought. In accordance with FIG. 6, znextx−min(z₀) and znextxmax(z₀) denote below the local minimum and the local maximum of f(z) between which z₀ lies, and, furthermore, znextx−zero(z₀) denotes the zero point of x(z)=f(z), which lies between znextx−min(z₀) and znextxmax(z₀).

The α-value α_{nextzero}(z₀):=α|_{z=z netxzero(z0)} belonging to this zero point is (because of equation (52030a) and (52040a)) clearly an integral multiple of π that differs from zₙₑₓₜₓₘᵢₙ(z₀) and zₙₑₓₜₓₘₐₓ(z₀) and by π/2, that is to say

$$\begin{matrix}{α}_{nextxzero} ( {z}_{0} ) := m π , & ( 52290 a ) \\ \begin{matrix}{α}_{nextxmin} ( {z}_{0} ) := m π - π / 2 , & if m is even , \\ := m π + π / 2 , & otherwise\end{matrix} & ( 52290 b ) \\ \begin{matrix}{α}_{nextxmax} ( {z}_{0} ) := m π + π / 2 , if m is even , \\ := m π - π / 2 , otherwise\end{matrix} \\ with m = 0 \text{,} 1 \text{,} 2 \text{,} … & ( 52290 b )\end{matrix}$$

Since the profile of the track signal f(z) is known, this m can be determined directly from z₀. The following is obtained by taking account of equation (52280):

$$m = 0 , if {z}_{0} < ( c / 2 ) {\{ [ 1 + ( 1 / c ) L ) ]}^{1 / 2} - 1 \} \\ m = 1 , if ( c / 2 ) \{ {[ 1 + ( 1 / c ) L ]}^{1 / 2} - 1 \} \leq {z}_{0} < ( c / 2 ) \{ {[ 1 + ( 3 / c ) L ]}^{1 / 2} - 1 \} \\ m = M , if ( c / 2 ) \{ {[ 1 + ( ( 2 M - 1 ) / c ) L ]}^{1 / 2} - 1 \} \leq {z}_{0} < ( c / 2 ) \{ {[ 1 + ( ( 2 M + 1 ) / c ) L ]}^{1 / 2} - 1 \} ( M = 1 \text{,} 2 \text{,} 3 \text{,} … ) . \qquad ( 52300 )$$

It therefore holds for the α value belonging to z₀ that

mπ−π/2≦α≦mπ+π/2 (52310)

The exact value is therefore obtained by the additional use of the measured value x as

$$\begin{matrix}α = m π + arcsin ( x ) for even m , \\ = m π - arcsin ( x ) for odd m .\end{matrix} \qquad ( 52320 )$$

Finally, the value being sought for z is obtained therefrom in a way corresponding to the case of the first method according to equation (52280).

This method can also be formulated in an obvious way for the measured value y instead of x.

If x lies very close to +1 (maximum) or −1 (minimum), the method can lead to incorrect results owing to inaccuracies of measurement and computation, because then the determination of m can lead to a value that is too high or too low by numeral 1. It is recommended in this case to apply the method for y. Conversely, if y lies very close to +1 or −1 the method for x should be applied.

A further evaluation of a sinusoidal track signal f(z) for determining the position z is explained in the following exemplary embodiment, the track signal being amplitude modulated, and not frequency modulated as in the previous exemplary embodiments. Here, the track signal f(z) is of single frequency in the exemplary embodiment. Along the lines of the exemplary embodiment in accordance with FIG. 1, such an amplitude modulated track signal can be generated by selecting, by contrast with the exemplary embodiment in accordance with FIG. 1, for all the period lengths L₁ to Lₖ of the increments I₁ to Iₖ to be equal, whereas the increments I₁ to Iₖ are magnetized at different strengths.

The track signal f(z) is given in this case by

f(z)=B(z)sin(2π/L) (53010)

with

B(z)=Bₙ for (n−1) L≦z<nL (Bₙ₁≠Bn2 for n1≠n2) (53020)

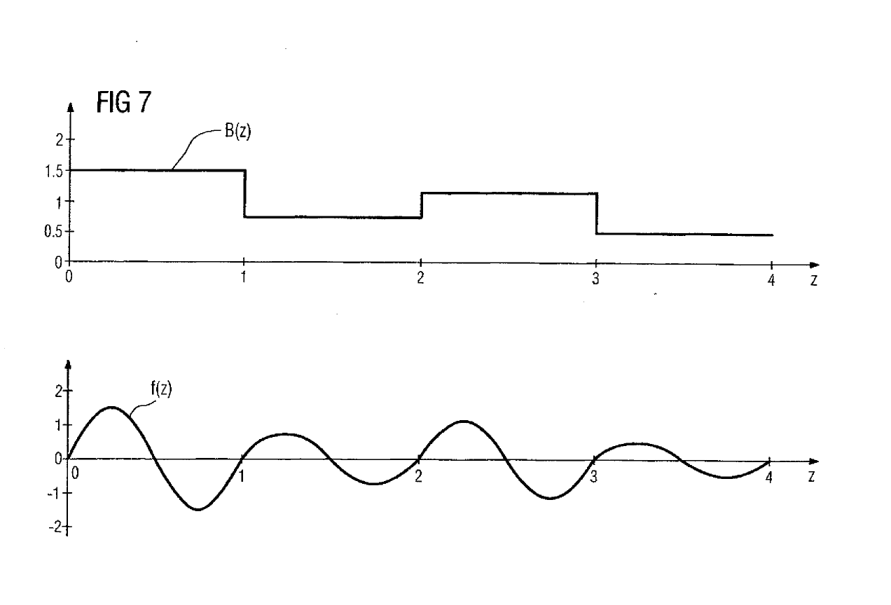

(see FIG. 7). The track signal f(z) is composed in this case of a number of consecutive sinusoidal periods of equal period length but different amplitude. The upper curve in FIG. 7 illustrates the profile of B(z) for the values L=1, B₁=1.5, B₂=0.75, B₃=1.15, B₄=0.5. The lower curve in FIG. 7 illustrates the resulting track signal f(z).

Here, the scanning head 1 has at least three sensors in the exemplary embodiment, their position relative to one another being given by

a₂=a₁+L/4, a₃=a₂+L/4=a₁+L/2. (53030)

This ensures that there are always at least two neighboring ones of these three sensors located inside the same sinusoidal period, and this permits a particularly simple evaluation. However, it is also possible to conceive in this regard evaluation methods that manage with only two sensors. Such a one is examined below.

Let

x₁:=f(z+a₁) (53040)

denote the track signal of the sensor No. i. Only the sign of these signals need then be evaluated in order to identify which of the three sensors is located within the same sinusoidal period. Specifically, it holds that:
for x₁≧0 all three sensors are located inside the same sinusoidal period,
for x₁<0, x₂≧0 sensor No. 2 and No. 3 are located inside the same sinusoidal period, and
for x₁<0, x₂<0 sensor No. 1 and No. 2 are located inside the same sinusoidal period.
Now let the sensors No. p and p+1 be in the same sinusoidal period, that is to say

(n−1)L≦z+aₚ<z+aₚ₊₁<nL. (53050)

Because of the trigonometric identity

(sin(φ))²+(cos(φ))²=1, it then holds that

xₚ²+xₚ₊₁²=Bₙ². (53060)

By evaluating xₚ²+xₚ₊₁², it is therefore possible firstly to determine the sinusoidal period within which xₚ is located (determination of coarse position; coarse evaluation).

In the subsequent fine evaluation, the position is finally determined more accurately as follows:

z=−aₚ+(n−1)L+(a tan 2(xₚ,xₚ₊₁)/(2π))L,

if a tan 2(xₚ₊₁,xₚ)≧0, (53070a)

z=−aₚ+(n−1)L+(2π+a tan 2(xₚ,xₚ₊₁)/(2π)L otherwise. (53070b)

### (Fine Evaluation by Means of Interpolation)

for the cases

### B₁<B₂< . . . <Bₙ₋₁<Bₙ< . . .

and

### B₁>B₂> . . . >Bₙ₋₁>Bₙ> . . . ,

the method just described can also be modified such that the position can be determined uniquely and accurately overall even with only the two sensors No. 1 and No. 2.

This may be illustrated briefly below for the case B₁<B₂< . . . <Bₙ₋₁<Bn . . . . Firstly, the signs of x₁ and x₂ are determined in accordance with the method just described. If x₁≧0 or x₁<0, x₂<0, the procedure is continued as in the method just described, since in these cases x₃ is not required there in any case. If, however, it holds that x₁<0, x₂≧0, that n for which it holds that

Bₙ₋₁≦x₁²+x₂²<Bₙ²

is determined. It then holds with this n that

(n−1/2)L≦z+a₁<nL.

The coarse position is thereby determined (coarse evaluation). Furthermore,

x′₂=(Bₙ₋₁²−x₁²)^{1/2} is determined for the fine evaluation.

The exact position (fine evaluation by means of interpolation) is then obtained by substituting p=1 and xₚ₊₁=x′₂ in equation (53070b).

The fact that only a single track is required for the invention is particularly decisive wherever it is no longer possible to implement a number of parallel tracks.

This is illustrated below with reference to a further exemplary embodiment in accordance with FIG. 8.

FIG. 8 illustrates an example of a further possible refinement of the inventive measuring element 2. A scanning head 1 that moves in the direction of the double arrow along the measuring element 2 and scans the material measure is illustrated. The material measure is implemented in this case by the 3-dimensional contour of the measuring element. The measuring element is implemented here in the form of a rotationally symmetrical element in particular a rack whose external tooth-shaped contour exhibits a frequency modulated sinusoidal shape. Here, the scanning head 1 has a permanent magnet and magnetic sensors. The spacing between measuring element 2 and scanning head 1, which varies during the movement of the scanning head 1 along the measuring element, generates frequency modulated sinusoidal fluctuations in the magnetic field between the scanning head 1 and the measuring element 2, as a result of which the sensors in the scanning head 1 generate a frequency modulated sinusoidal output signal as track signal. Since the metrological imaging of the contour of the measuring element 1 in the track signal generally exhibits a lowpass characteristic, an amplitude modulation of the contour of the measuring element 2 is additionally carried out in such a way that the amplitude of the track signal generated by the respective sensor is constant. To this end, the external contour of the rack has a profile in which the highs and lows of the teeth in the contour are greater the shorter the relevant teeth/tooth gaps. If, for example for reasons of mechanical design, it is necessary to rotate the scanning head 1 and/or the measuring element 2 in rotary fashion about the axis of rotation (depicted by dots and dashes) of the measuring element 1 during the measurement, this has no influence on the measurement, nor therefore on the determination of the position Z.

It may further be pointed out at this juncture that instead of designing the measuring element 2 and the material measure 3 as linear elements for acquiring a linear movement as in the exemplary embodiments, it is also conceivable that the measuring element and the material measure can also be present as rotary elements (for example in the form of a round plate) for acquiring a rotary movement. In this case, the scanning head is usually, for example, embodied in a transmitter in a stationary fashion, while the measuring element with the material measure rotates below the scanning head.

While the invention has been illustrated and described in connection with currently preferred embodiments shown and described in detail, it is not intended to be limited to the details shown since various modifications and structural changes may be made without departing in any way from the spirit of the present invention. For example, optical sensors can be used instead of the magnetic sensors, wherein the material measure would then include optical increments. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A measuring element, comprising:
a track having a material measure; and
at least two sensors scanning the material measure for determining a position value and generating as an output signal a frequency-modulated sinusoidal track signal,
wherein the frequency of the track signal increases monotonically or decreases monotonically when the position value increases.

2. A measuring element, comprising:
a track having a material measure, and
at least two sensors scanning the material measure for determining a position value and generating as an output signal an amplitude-modulated sinusoidal track signal,
wherein the amplitude-modulated sinusoidal track signal has a single frequency.

3. The measuring element of claim 1, comprising at least three sensors scanning the material measure for determining a position value.

4. The measuring element of claim 1, wherein the measuring element is configured as a rotationally symmetrical element with an outer contour having a frequency-modulated sinusoidal shape.

5. The measuring element of claim 2, comprising at least three sensors scanning the material measure for determining a position value.

6. The measuring element of claim 2, wherein the measuring element is configured as a rotationally symmetrical element with an outer contour having a frequency-modulated sinusoidal shape.

7. A transmitter with a measuring element of claim 1.

8. A transmitter with a measuring element of claim 2.

9. A machine tool, production machine or robot with a transmitter as claimed in claim 7.

10. A machine tool, production machine or robot with a transmitter as claimed in claim 8.

11. A measurement method for determining a position value with a track having a material measure, comprising the steps of:
scanning the material measure with at least two sensors, and
generating a sensor output signal in form of a frequency-modulated sinusoidal track signal to determine the position value,
wherein the frequency of the frequency-modulated track signal increases monotonically or decreases monotonically with increasing position value.

12. A measurement method for determining a position value with a track having a material measure, comprising the steps of:
scanning the material measure with at least two sensors, and
generating a sensor output signal in form of an amplitude-modulated sinusoidal track signal having a single frequency to determine the position value.

13. The measurement method of claim 11, wherein the position value is determined by first determining from the track signals of the sensors a coarse position, and subsequently determining the position value from the coarse position through interpolation.

14. The measurement method of claim 12, wherein the position value is determined by first determining from the track signals of the sensors a coarse position, and subsequently determining the position value from the coarse position through interpolation.
